(19) United States
(12) Patent Application Publication
(10) Pub. No.: US 2003/0103651 A1
(43) Pub. Date: Jun. 5, 2003

(54) Photogrammetric apparatus

(76) Inventor: Kurt Novak, Dublin, OH (US)

Correspondence Address: Sean M. Casey Co., L.P.A., Attention: Sean M. Casey, P.O. Box 710, New Albany, OH, 43054-0710, US

(21) Appl. No.: 10/005,273

(22) Filed: Dec. 3, 2001

(51) Int. Cl. G06K 9/00; G06K 9/40; G06K 9/36

(52) U.S. Cl. 382/106; 382/255; 382/291

(57) ABSTRACT

A photogrammetric apparatus for capturing a single image of an object, capturing a plurality of data about the image, analyzing the data, and computing relationships between substantially coplanar points in the image. The apparatus includes an image capturing device that captures images and stores the images in a storage device with database. The database simultaneously receives and stores data from a bearing finding device, a range finding device, and an azimuth finding device. The apparatus may include a global positioning system (GPS) device to collect and store to the database a geophysical location of the image capturing device when the image was captured. The apparatus includes an image processor to analyze the images and data stored in the database. The image processor includes routines for calibrating the apparatus, measuring distances between substantially coplanar points in the image, and calculating a plurality of relationships among various coplanar points in the image.

### TECHNICAL FIELD

This invention relates to a photogrammetric apparatus for use in a wide variety applications that include, among others, surveying, engineering, architectural, crime and accident scene investigation, quality assurance, nondestructive testing, structural deformation analysis, and similar applications that can benefit from improved photogrammetric data capture and analysis techniques.

### BACKGROUND OF THE INVENTION

In the various pertinent industries, including for purposes of illustration but not limitation, surveying, those with skill in the art have long-recognized the need for an improved system and method for utilizing non-professional or less skilled personnel (for example, individuals other than high-salary, certified surveyors, who may have limited availability) to accurately gather geophysical, configuration, and arrangement information of, for example, land, buildings, and off-road and roadside utility equipment. In the past, gathering of such information traditionally required extensive knowledge of geometry, surveying, and engineering to ensure that the information obtained was accurate with respect to equipment and asset identification and configuration, as well as to geographic location and arrangement.

Gathering information in the field is a labor-intensive process with the potential for large margins of error, which can result in expensive and time-consuming duplication of effort to correct mistakes. In the present day information age, many attempts have been made to improve the state of the art of such information gathering efforts by incorporating modem technology. Yet even today it is common to see a traditional two or three man survey crew along the roadside manually gathering information about land, buildings, and electric and communications utilities, often times scribbling hand written notes or attempting to manually enter information into laptop computers. The quality of the information gathered by such survey crews varies with the geographical conditions, weather, the time of day, and the skill of the surveyors.

After gathering the needed information, the survey crew often then returns to the office and turns over the information gathered to a separate group of surveyors, or engineers, for analysis. The in-office analysis is a difficult process because the office personnel must then decipher the notes and data collected by the field crew and tabulate the data into a computer system. The surveyors, or engineers, in the office often need several meetings with the field crew to ensure that they are accurately interpreting the collected data. These meetings are further necessitated by the fact that the office personnel rarely actually view the locations from which the collected information was obtained. As a result, the field crews are often required to incur several return trips to gather corrected and additional information that is required for the office analysis.

In the noted example of the surveying profession, surveyors and engineers alike have recognized the value of photographs in the analysis of field information. While photographs can often eliminate the need for return visit to the field site, the survey crew must still explain to the office personnel the location and significance of each photograph. Even still, the process remains very inefficient since inaccurately recorded photograph angles, locations, and related data can induce unexpected and unverifiable errors into the analysis process.

Many prior art attempts have been made to advance that state of the art of surveying equipment and to minimize the inefficiencies inherent in the process of gathering information in the field and in conducting office analysis. For example, in U.S. Pat. No. 6,194,694 to Shirai, sighting telescopes and auto-focusing systems have been added to traditional surveying equipment. However, educated surveyors or technicians are still required to operate the equipment since the techniques for use require higher educational and technical knowledge.

The need remains for an apparatus that provides a single, comparatively untrained worker to accurately collect and conveniently store field data for subsequent analysis in the office. Frequently the desired data takes the form of information that can be gathered from an object substantially located in a single plane within a field of view. For example, an architect may need to obtain the exterior dimensions of a building from the planar images of each side thereof. In a further example, engineers need to collect utility pole data such as pole height, pole diameter, the height of attachments such as electrical and communications cables, transformers, and similar information. Ideally this information would be collected and stored for later analysis back in the office without the need for complicated in field set up and breakdown of measuring equipment for each location to be identified and analyzed.

Prior art apparatus and methods for collecting accurate information in the field have been complicated, costly, and not adapted for ease of use by a single operator, who may not have training in the field of, for example, surveying. Such prior art apparatus and methods involve the technical field of photogrammetry. The field of photogrammetry has been dominated by highly trained individuals and complex computer systems and software that require the use of two images of the same object from different locations that are then overlaid and analyzed to compute coordinates of unknown points in the image. For example, as in U.S. Pat. No. 6,310,644 to Keightley, two tower mounted camera assemblies, or a single camera with a beam splitter, are used to create a three-dimensional coordinate system from at least two photographs. Similarly, U.S. Pat. No. 6,304,669 to Kaneko et al. is limited to the use of two photographs of the target object from different locations to produce a survey map. Additionally, U.S. Pat. No. 5,216,476 utilizes two stereo cameras to create three-dimensional coordinate systems.

What continues to be missing from the technical field of photogrammetry is a solution to the need for inexpensively gathering field information while ensuring accuracy and ease of retrieval, as well as improved computer analysis capabilities that do not require highly trained individuals to operate or expensive budgets for high-performance equipment. While many of the prior art devices aimed to improve these attributes in the art of such devices, none has achieved an optimized capability in an easy to use form that is readily suited to application in the myriad industries that have demonstrated a need for analysis of field gathered data and photogrammetric information.

What has been needed but heretofor unavailable in the prior art devices and methods, is a low-cost, user friendly, photogrammetric apparatus for determining distances between substantially coplanar points in a single image. The term coplanar used herein refers to the conventional use in the context of geometric applications, which is distinguished from the specialized use of “coplanar” in the context of stereo photogrammetry techniques. The use of the geometric term coplanar herein aids in the description of points in the single image photogrammetric techniques as employed according to the principles of the present invention. The most preferable photogrammetric apparatus would be compatible for use in wide-ranging applications including, but not limited to, architecture, engineering, surveying, crime and accident scene investigation, quality assurance, nondestructive testing, deformation analysis, among many other situations that require accurate, low-cost analysis of data that can include, for example, substantially coplanar points in a single image of a field location.

The present invention meets these and other needs without adding any complexity, inefficiencies, or significant costs to implementation in existing applications and environments. In fact, the preferred photogrammetric apparatus according to the present invention can be implemented with relatively low-cost measurement and computer components that can be adapted according the to the principles of the present invention. The various embodiments of the present invention disclosed are readily adapted for such preferred ease of manufacture, low fabrication and setup costs, and compatibility with off the shelf components.

### SUMMARY OF INVENTION

In its most general configuration, the present invention advances the state of the art with a variety of new capabilities and overcomes many of the shortcomings in new and novel ways. In one of the many preferable configurations, the photogrammetric apparatus incorporates, among other elements, a storage device for receiving and storing information in a database gathered from a plurality of other elements in the apparatus.

In one of many variations of the instant invention, that apparatus includes an image capturing device having a imager, such as a digital camera, that captures images and automatically stores the images in the database. The database is also adapted to simultaneously receive and store data from a bearing finding device, a range finding device, and an azimuth finding device. The bearing finding device preferably collects and communicates to the database information regarding a heading to which the image capture device is pointing. The range finding device similarly collects and transmits to the database information regarding a distance of a target object from the image capture device. The azimuth collection device collects and saves to the database an angle of the image capture device axis from vertical.

A further variation of any of the preceding embodiments may also further include an angle measurement means for obtaining angles other than azimuth angles that may be needed for measurements in non-vertical target object applications. Therefore, in place of the azimuth collection device used on approximately vertical target objects, the angle measurement means is adapted to collect and transmit to the database information regarding the orthogonal distance from the image capture device to the non-vertical target object.

Any of the preceding configurations and embodiments may also be adapted to include a global positioning system (GPS) device to collect and store to the database a geophysical location of the image capturing device when the image was captured.

The present invention also further preferably includes an image processor configured to analyze the images and data stored in the database. In one of the many preferred cap-abilities and routines of the image processor, a calibration routine is adapted to determine a focal length of the image capturing device in a pixel unit of measure using points in the captured image. The preferred routine utilizes a calibration image of a real-world calibration target containing a plurality of target indicia that establish a pattern of points and or geometric relationship having known, predetermined distances and arrangements. The calibration routine is further adapted to account for a radial optical distortion inherent in the lens of the image capture device. Upon image capture, the calibration routine can analyze the target indicia of the calibration image. The calibration compares the imaged target indicia with the known, predetermined distances and relationships and to measure the distance between the target indicia in a corresponding pixel unit of measure. From this information, the image processor and calibration routine determines a set of scale ratios of the real distances between the target indicia to the pixel unit of measure distances on the image. This is accomplished for a plurality of the target indicia, and the results are then averaged into an average scale ratio, which is then used to calculate a calibrated focal length in pixel units of measure for the image capturing device.

The calibrated photogrammetric apparatus also includes a measurement routine that accepts inputs from a user viewing the captured and processed image of at least two points in the image that are substantially coplanar on the real world target of interest. As described above, the term “coplanar” as used herein has a specialized meaning in the context of the instant invention. The measurement routine is configured to retrieve data from the storage device database and to determine a distance between the points using the calibration date set and a series of trigonometric calculations. The measurement routine may be used to measure the distance between points on substantially coplanar objects or other, different points in the image. For example, the distance between various points on a substantially coplanar utility pole may be calculated. More specifically, the point can correspond to cables or equipment on the pole. In similar fashion, the amount of sag in a conductor between such poles can also be calculated.

Additional routines of the image processor are included in the present invention that are configured to calculate a number of geometric relationships between selected elements in the image. Such relationships may determine, for purposes of example without limitation, a diameter and a circumference of a substantially planar substantially cylindrical object in the image. For instance, the operator may select a point in the image on each side of the cylindrical object for the measurement routine to determine the distance between the points. The routine can calculate the diameter of the cylindrical object at any point on the object from the image. The point of the desired diameter does not have to be on an image axis. The measurement routine calculates a diameter point image scale for use in calculating the diameter when it is not on the image axis. This routine enables the user to determine the largest and smallest diameter along a substantially cylindrical object that actually tapers. With the diameter known, a myriad of other calculations may be performed including, for instance, a circumference calculation, a surface area calculation, and a volume calculation. In addition to the cylindrical objects, an area and a perimeter of all planar geometric shapes may be easily calculated. From this information, various other data and relationships may be derived, including volumetric and mass data.

The image processor may also include a global positioning system (“GPS”) coordinate routine adapted to establish the geophysical coordinates of a target object. This routine utilizes the actual geophysical location of the photogrammetric apparatus and or image capture device in conjunction with the captured and processed image and database information to determine a translated coordinate set that establishes the GPS coordinate set of the target object. This aspect of the present invention is unique in that it enables the user to remotely safely locate and analyze target objects using a single image of the target that may be directly inaccessible without exposing personnel to undue risk of harm or significant inconvenience or exertion.

The physical configuration of the photogrammetry apparatus may take a number of configurations. In one preferred configuration the image capture device, the storage device and database, and the bearing, range, azimuth, and global positioning system coordinate finding devices are all contained in a single housing that may be, for example, only slightly larger than a current day digital camera. The housing may include a high speed data transmission port that can be easily joined to a traditional computer system, similar to the universal serial bus (USB) joining and transmission methods of modem digital cameras. The computer system may contain a second database similar to the storage device database for receiving the information from the apparatus as well as the image processor. The computer system facilitates the use of various data input devices such as a keyboard and a mouse to enter data and a monitor to view the images and data. Further variations of the present invention include configurations for use with a personal digital assistant, a laptop computer, and other transportable processing and input devices for on-site analysis of the collected data.

In yet another configuration, the apparatus may include a transportation means such as a backpack to house majority of the apparatus with an external image capture device. Such configuration enables the use of a reduced size image capture device and enables the user to complete other tasks without interference of the apparatus. In a further variation, the image capture device is attached to an adjustable bracket secured to a construction type hardhat, or other safety helmet. In this configuration, the image capture device can be easily aligned with an eye when in use and rotated out of the line of sight while performing other tasks. A remote initiation button may be used with any of the described embodiments.

In variations of the preceding configurations, the enclosure material and construction of the photogrammetric apparatus is selected to be a impact resistant and durable material that resists abrasion wear and that can withstand exposure to severe weather and deleterious fluids and substances, such as, without limitation, biological, and industrial fluids and substances. Some such exemplary substances and fluids include steam, high temperature water, cleaning fluids, petrochemicals, biological fluids, oil, grease, bacteria, fungi, insects, pests, and raw and prepared agricultural food stuffs, to name a few.

The enclosure may also include any number of surface textures in a non-slip gripping surface including, for example, work and grip surfaces that are also formed to have stipple and or dimple patterns of raised portions. Further, the enclosure may include a plurality of connection points for safety straps and other securing means.

More specifically, any of the preceding embodiments may include a plurality of to expansion ports for integration of a plurality of external devices such as date and time recordation devices, GPS devices, temperature and humidity measuring devices, wind speed and direction measuring devices, barometric pressure measuring devices, altitude measuring devices, dosimeters, modems, wireless data transmission devices, emergency signal transmitters, two-way radios and printers.

These variations, modifications, and alterations of the various preferred embodiments may be used either alone or in combination with one another as can be better understood by those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures, wherein like reference numerals and numerals with primes across the several drawings, figures, and views refer to identical, corresponding, and or equivalent elements, features, components, and parts:

FIG. 1 is an elevation view, in reduced scale, of a photogrammetric apparatus according to the present invention and configured to capture an image of a cylindrical object;

FIG. 2 is a functional block diagram of the photogrammetric apparatus illustrated in FIG. 1 and according to the present invention;

FIG. 3 is a plan view, in reduced scale, that describes the various angles, dimensions, and reference points identified with the calibration and measurement devices and routines of the photogrammetric apparatus according to the present invention;

FIG. 4 is a functional block diagram of the calibration device and process according to the present invention;

FIG. 5 is an elevation view, in reduced scale, of the various angles, dimensions, and reference points identified in connection with the detailed description of the photogrammetric apparatus according to the present invention;

FIG. 6 is a functional block diagram of the measurement device and routine according to the present invention;

FIG. 7 is a block diagram of the diameter and circumference measurement device and routine according to the present invention;

FIG. 8 is a block diagram of the target object GPS coordinate measurement device and routine according to the present invention;

FIG. 9 is a plan view, in reduced scale, of the various angles, dimensions, and reference points identified in the detailed description of the diameter and circumference measurement and device routine of the photogrammetric apparatus according to the present invention; and

FIG. 10 is an elevation view, in reduced scale, of the various angles, dimensions, and reference points identified in connection with the detailed description of the additional capabilities of photogrammetric apparatus according to the present invention.

Also, in the various figures and drawings, the following reference symbols and letters are used to identify the various angles, dimensions, objects, and arrangements of elements described herein below in connection with the several figures and illustrations: A, B′, b, β₅, Δβ_{A}, Δβ_{R}, C′, C1, C2, c, DA, DM, DH, D′, d, E, e, F, f, f_{A}, fp, G, G′, g, H′, H1, H2, H3, h, IA, IP, P, P_{A}, P_{R}, P_{c}, P1, P2, R, RS, SP1, SP2, S, V_{A}, V_{R}, and W.

### DESCRIPTION OF THE PREFERRED EMBODIMENT

The photogrammetric apparatus according to the present invention demonstrates a significant step forward in the field of single image photogrammetry. Many ineffective and unsuccessful attempts have been made to create a photogrammetric apparatus having the convenience and efficiency of the present invention. The preferred photogrammetric apparatus practiced with the principles of the instant invention has wide application for architecture, engineering, surveying, facilities management, and investigation professionals, who have long sought a light, durable, high automated, and easily transportable photogrammetric apparatus that can be easily cleaned, stored, and transported at the conclusion of the work period with minimal effort and inconvenience. The preferred configurations and described alternatives, modifications, and variations of the photogrammetric apparatus of the instant invention overcome prior shortcomings and accomplish new and novel solutions to the prior art problems with vastly improved configurations and arrangements of inventive elements that are uniquely configured, and which demonstrate previously unavailable capabilities.

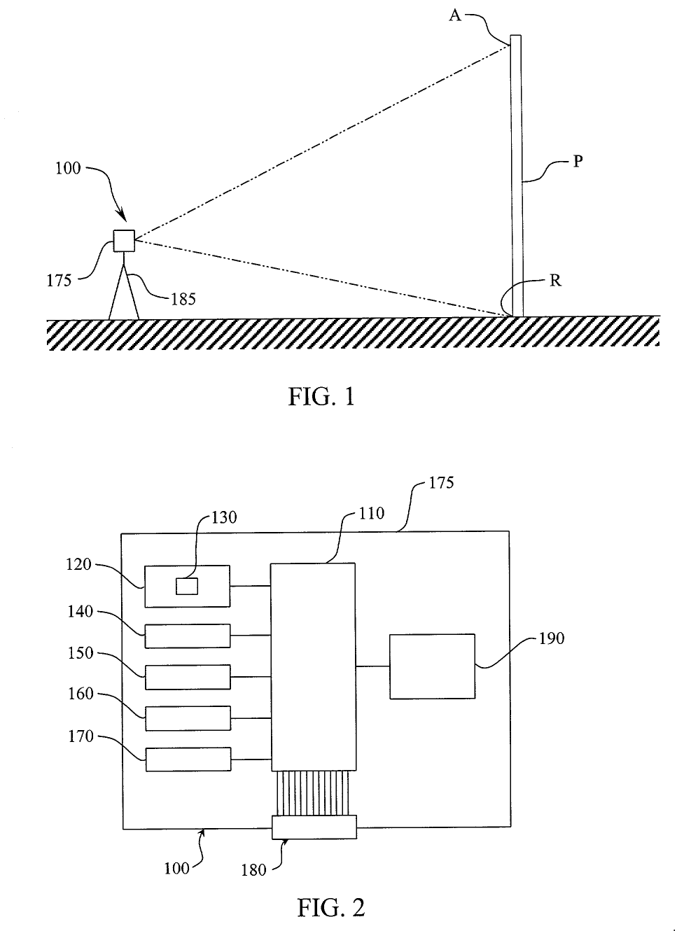

With reference now to the accompanying figures and specifically to FIGS. 1 and 2, in one of the many preferable arrangements, the photogrammetric apparatus 100 includes an image capturing device 120 having an imager 130, such as a digital camera, that captures images and automatically saves the images to a storage device with a database 110. The storage device and database 110 simultaneously receive and store data from a bearing 140 finding device, a range 150 finding device, and an azimuth 160 finding device. Each of such devices may be separate components, or may be combined into a single physical unit for convenience.

The bearing finding device 140 is adapted to collect and send to the storage device database 110 information regarding a heading to which the image capture device 120 is oriented. The bearing finding device 140 may take the form of a plurality of devices, however it is preferably a digital compass, such as, for illustration purposes without limitation, a solid-state, magnetic flux gate compass.

The range finding device 150 collects and saves to the storage device database 110 information regarding a real distance of a target object from the image capture device 120. While the range finding device 150 may utilize any number of widely known distance measuring devices, it is preferably a laser range finder.

The azimuth collection device 160 collects and saves to the storage device database 110 an angle of the image capture device 120 axis from an imaginary vertical line. The azimuth collection device 160 is preferably an inclinometer, but may configured with any number of equally suitable devices and technologies.

A further variation of any of the preceding embodiments may also further include an angle measurement means for obtaining angles other than azimuth angles that may be needed for measurements in non-vertical target object applications. Therefore, in place of the azimuth collection device used on approximately vertical target objects, the angle measurement means is adapted to collect and transmit to the database information regarding the orthogonal distance from the image capture device to the non-vertical target object. The angle measurement means may incorporate elements as simple as a right angle square, as used by carpenters, to physically ensure that the apparatus 100 is aligned orthogonal to the non-vertical target, or elements as sophisticated as object image recognition software that inform the user when the target image is aligned orthogonal to the non-vertical target object. A plurality of additional measurement means varying from the simple square to the sophisticated software may be used with the present invention.

Any of the preceding configurations and embodiments may also be adapted to include a global positioning system (GPS) device 170 configured to communicate to the storage device database 110 a geophysical location of the image capturing device 120 at about the time when the image was captured.

The photogrammetric apparatus 100 may take a number of physical configurations. In one preferred configuration the image capture device 120, the storage device and database 110, and the bearing 140, range 150, azimuth 160, and GPS coordinate 170 finding devices are all contained in a single housing 175 slightly larger than a modern digital camera. The housing 175 includes an expandable external device port assembly 180 that may include high-speed data transmission ports and expansion ports for integration of a plurality external devices. The expandable external device port assembly 180 may provide two way data transmission between a plurality of external devices, including for example computer systems, date and time recordation devices, GPS devices, temperature and humidity measuring devices, wind speed and direction measuring devices, barometric pressure measuring devices, altitude measuring devices, dosimeters, modems, wireless data transmission devices, emergency signal transmitters, two-way radios and printers.

The preferred photogrammetric apparatus 100 and included computer system may also preferably contain a second database similar to the storage device database for receiving the information from the apparatus as well as the image processor. The computer system facilitates the use of various data input devices. For example, input devices such as a keyboard, a mouse, a trackball, a digitizer, and a headset may be used to enter data and a monitor to view the images and data. Further variations of the present invention include configurations for use with a personal digital assistant, a laptop computer, and other transportable processing and input devices for on-site analysis of the collected data.

The apparatus 100 may be secured to a mounting device 185. The mounting device 185 may include a tripod or any adjustable support device. In yet another configuration, the apparatus 100 may include a transportation means such as a backpack to house majority of the apparatus 100 with an external image capture device 120. Such configuration enables the use of a reduced size image capture device 120 and enables the user to complete other tasks without interference of the apparatus 100. In a further variation, the image capture device 120 is attached to an adjustable bracket secured to a construction type hard hat, or other safety helmet. In this configuration, the image capture device 120 can be easily aligned with an eye when in use and rotated out of the line of sight while performing other tasks. A remote initiation button 105 may be used with any of the described embodiments.

In variations of the preceding configurations, the housing 175 material and construction of the photogrammetric apparatus 100 is selected to be a impact resistant and durable material that resists abrasion wear and that can withstand exposure to severe weather and deleterious fluids and substances, such as, without limitation, biological, and industrial fluids and substances. Some such exemplary substances and fluids include steam, high temperature water, cleaning fluids, petrochemicals, biological fluids, oil, grease, bacteria, fungi, insects, pests, and raw and prepared agricultural food stuffs, to name a few.

The housing 175 may also include any number of surface textures in a non-slip gripping surface including, for example, work and grip surfaces that are also formed to have stipple and or dimple patterns of raised portions. Further, the housing 175 may include a plurality of connection points for safety straps and other securing means.

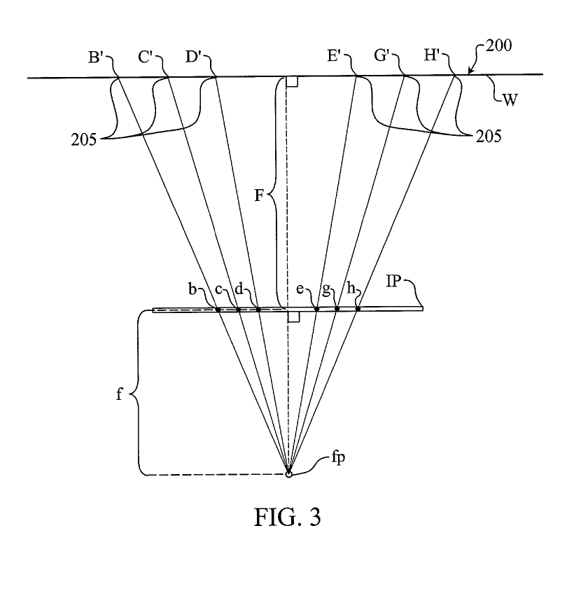

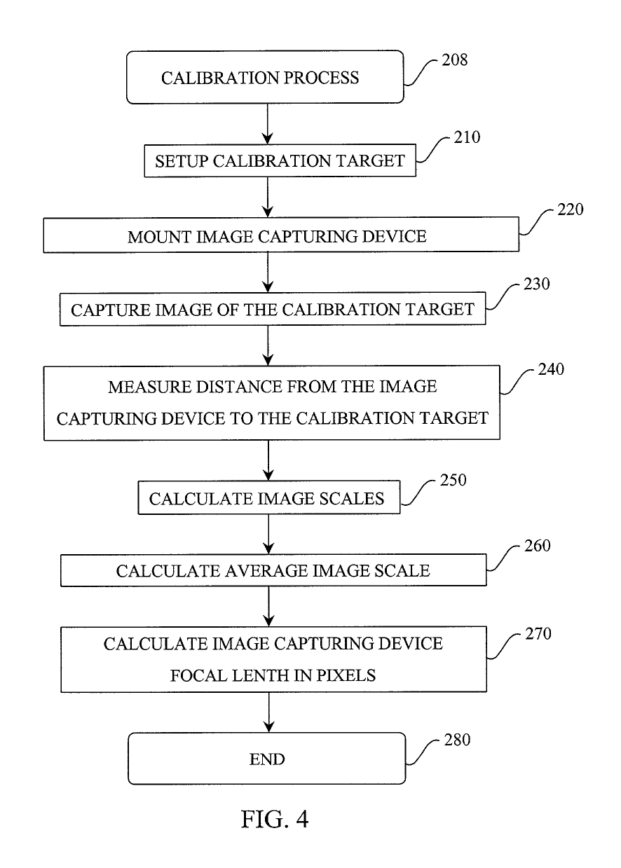

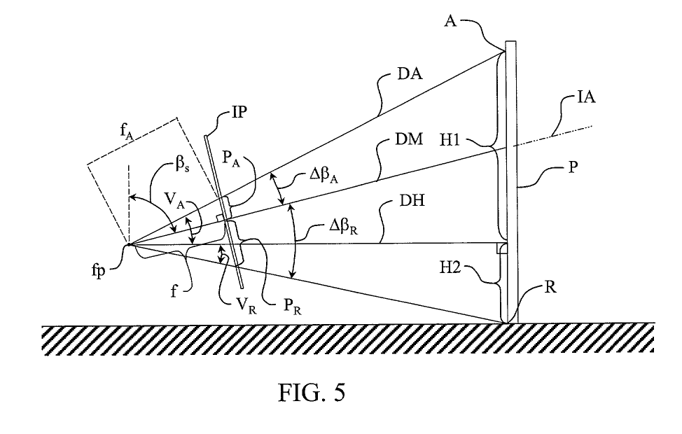

Now referring to FIGS. 3 and 4, the calibration device and routine is adapted to determine an actual distance per pixel value, taking into account radial distortion, as well as a focal length of the image capture device in units of pixels. The calibration process begins with the capture of an image of a calibration target that includes at least two calibration indicia having a predetermined and known geometric relationship. The calibration image should preferably be captured at an angle orthogonal to the capturing device image axis “IA” indicated in FIG. 5.

Many processes for calibrating image capture devices to account for distortions in the image have been developed over the years. Virtually all of the calibration methods use essentially the same parameters including camera position, camera orientation, lens focal length, lens radial distortion, pixel array size, and the optical axis location.

One embodiment of the present invention utilizes an efficient device and method to account for radial distortion. Referring again to FIG. 3 and FIG. 4, the calibration target 200 may be configured in a number of ways with various target indicia 205. The calibration target 200 should extend across the full range of the object that is to be imaged. For example, if the apparatus is used to capture images and data from a plurality of utility poles that are approximately 25-30 feet tall, then the calibration image would ideally be approximately 30-35 feet. Such a calibration target can easily be created by utilizing an exterior wall of a building to mount target indicia 205.

An exemplary configuration may use 0.5 centimeter square target indicia 205 located in pairs separated by four to six feet horizontally across the length of the desired target. At least three pair of target indicia 205, mounted at points B′, C′, D′, E′, G′, H′, are desired such that a pair is approximately at each extremity of the image and a pair is approximately at the center of the image, refer to FIG. 3.

A further embodiment of the calibration target 200 may include a lightweight mat with uniformly spaced target indicia 205. The mat may be constructed of a lightweight plastic or fabric that can be easily folded or rolled. The mat is preferably several hundred feet long, approximately 2-12 inches wide, and packaged in a automatic retractable housing for convenient storage and use. The mat may include a plurality of mounting devices such as rings or hanger devices. The mat may be easily hung from the side of a structure or set-up in a field with lightweight mounting tines that may be forced into the earth. Another embodiment may consist of essentially a rope with equally spaced target indicia 205.

Continuing with the calibration process 208 exemplary configuration of FIG. 3, upon completion of the calibration target setup 210, the image capturing device 120 is setup 220. The image capturing device 120 is aligned so the axis of the imager 130 is orthogonal to the calibration target 200. Further, the image capturing device 120 is rotated ninety degrees so the horizontally mounted target indicia 205 are parallel with the vertical image direction of the imager 130. This process 220 ensures the image capturing device 120 is calibrated in the same to orientation as the objects to be imaged, utility poles in the present example.

With the image capture device 120 setup 220 complete, a calibration image 235 is captured and saved in the storage device database 110. One with skill in the art would recognize that a similar calibration image 235 may be captured for objects of any orientation. The calibration image 235 is captured when the user depresses the apparatus initiation button 105. The initiation button 105 activates a plurality of devices in the apparatus 100 to collect data. However, in the calibration process the initiation button 105 only activates the image capture device 120, 230 and the range finding device 150, 240. The distance “F” from the image capture device 120 to the calibration target 200 collected from the range finding device 150 is stored in the storage device database 110. Data from the other data collection devices is not needed in the exemplary calibration process because the axis of the image capture device 120 is orthogonal to the calibration target 200. When the apparatus 100 is not in the calibration process the depression of the initiation button 105 will initiate the capture and storage of data from all the connected devices including, for example, the bearing finding device 140, the azimuth finding device 160, the GPS coordinate finding device 170, and the plurality of integrated external data collection devices connected to the external device port assembly 180.

Referring still to FIG. 3 and FIG. 4, the calibration process proceeds with the retrieval of the calibration image 235 and the distance “F” from the storage device database 110 by the image processor 190. During the calibration process, the image processor 190 calculates a plurality of image scales 250, an average image scale 260, and the focal length “f” 270 of the imager 130 in pixel units.

In the example illustrated in FIG. 3, image scales would be computed by the image processor 190 consisting of ratios of the actual distance between reference points B′ and C′ on the calibration target 200 to the pixel distance between the corresponding image plane “IP” reference points “b” and “c”. Similar image scales would be computed for reference points D′-E′ and reference points G′-H′.

Another embodiment of the image processor 190 enables the user to select the target indicia 205 on the calibration image 235. Alternative embodiments of the image processor 190 are automated to discriminate the target indicia 205 from the surroundings in the calibration image 235. Regardless of the image processor 190 embodiment, the user will enter the actual distance between the target indicia 205 and the image processor 190 will save the data to the storage device database 110. Once the target indicia 205 are identified, the image processor 190 will determine the pixel distances between the target indicia 205 and the plurality image scales 250. The image processor 190 will further calculate an average image scale 260 that may then be used to assign actual distances to pixel distance. Additionally, the image processor 190 will calculate the focal length “f”, 270 in pixel units by dividing actual distance “F” from the image plane “IP” to the calibration target 200 by the previously computed average image scale.

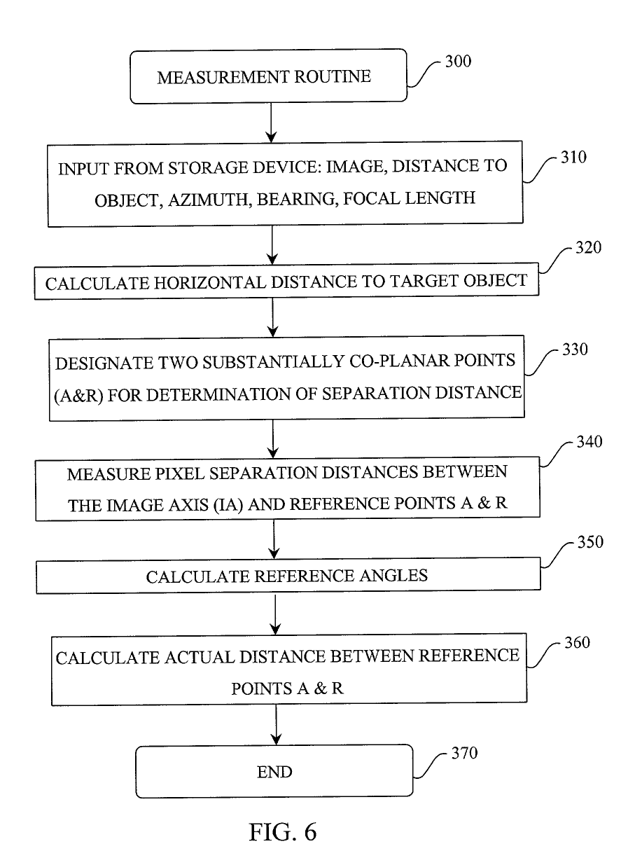

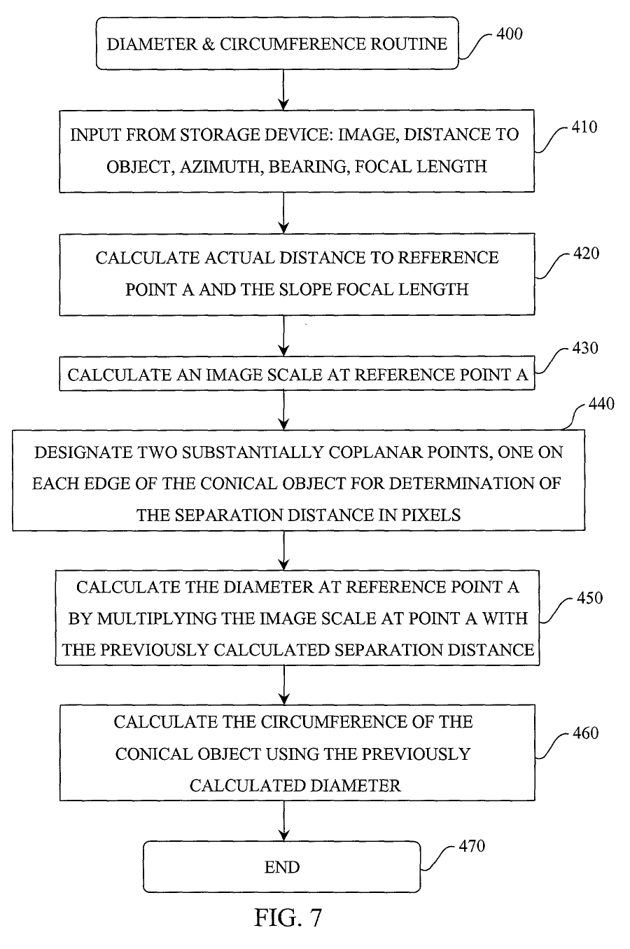

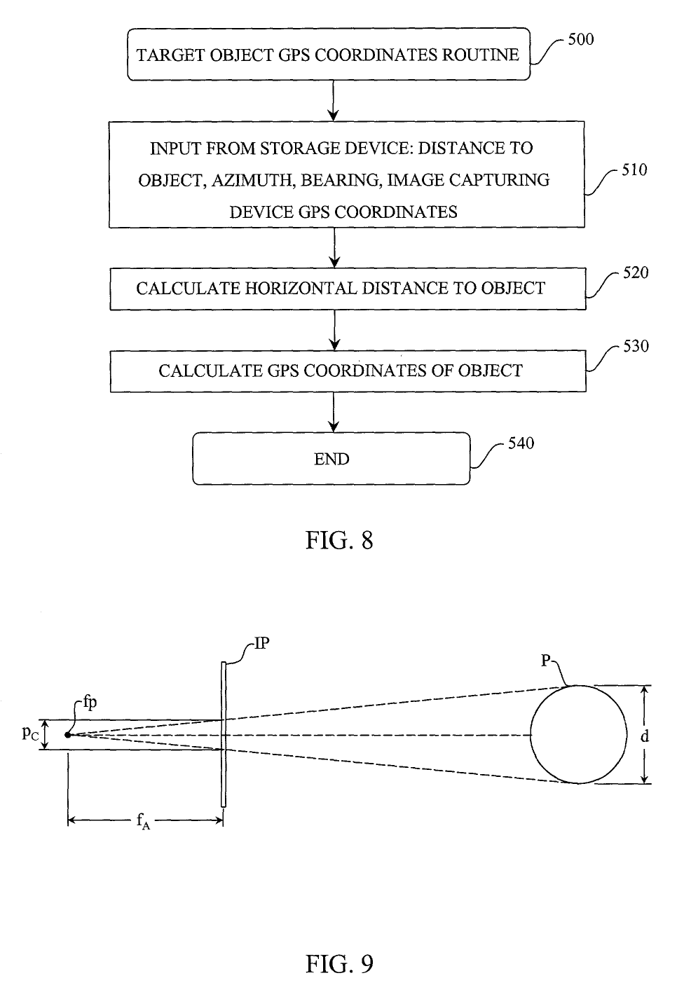

Now with reference to FIG. 5 and FIG. 6, the image processor 190 may retrieve the average image scale from the storage device database 110 for use in a measurement routine 300. The measurement routine is typically performed in an office environment after data has been collected in the field.

Referring again to the example of surveying utility poles, an unskilled worker can easily operate the apparatus 100 by simply aiming the image capture device 120 at the target utility pole and depressing the initiation button 105. To the user the data collection process is as easy as taking a photo. Simply depressing the initiation button 105 commands collection and storage of data from all the connected devices including, for example, the range finding device 150, the bearing finding device 140, the azimuth finding device 160, the GPS coordinate finding device 170, and the plurality of integrated external data collection devices connected to the external device port assembly 180. For example, the user may aim the apparatus 100 at the utility pole “P” and depress the initiation button 105. The range finding device 150 collects and stores to the storage device database 110 the distance “DM” from the apparatus 100 to the utility pole “P” along the image axis “IA”. The bearing finding device 140 collects and stores to the storage device database 110 the heading of the apparatus 100 image axis “IA”. The azimuth finding device 160 collects and stores to the storage device database 110 the angle “βₛ” of the image axis “IA” from an imaginary vertical line. One with skill in the art can appreciate that alternative embodiments may measure an angle of the image axis “IA” from a number of other reference lines and the equations modified accordingly. For example, another embodiment may measure the angle of the image axis “IA” from an imaginary orthogonal reference line. Such a modified image axis “IA” measurement system would be used in embodiments utilizing non-vertical target object. In a further embodiment, the GPS measurement device 170 collects and stores to the storage device database 110 the geophysical coordinates of the apparatus 100. Skilled workers may then analyze the images and multitude of data stored in the storage device database 110.

Referring still to FIG. 5 and FIG. 6, and the utility pole example, the first step 310 in the measurement routine is for the image processor 190 to retrieve an image and all associated data from the storage device database 110 for analysis. The second step 320 is to calculate the horizontal distance “DH” from the focal point “fₚ” of the apparatus 100 to the pole “P”. The focal point “fₚ” referred to herein is also commonly referred to as the perspective center “O” in the field of photogrammetry. The horizontal distance “DH” can be calculated using trigonometric relationships between the known angle “βₛ” and the known measured distance “DM”. Next, to calculate reference angles “Δβ_{A}” and “Δβ_{R}” the distances of reference points “A” and “R” from the image axis “IA” in pixel units must be determined 340. The measurement routine will automatically determine pixel distances “P_{A}” and “P_{R}”. Further, with “P_{A}”, “P_{R}”, and “f” known in terms of pixel units, reference angles “Δβ_{A}” and “Δβ_{R}” may be calculated 350 using simple trigonometry. Reference angles from the horizontal “V_{A}” and “V_{R}” may be calculated once reference angles “Δβ_{A}” and “Δβ_{R}” are known. Finally, the actual distance between reference points “A” and “R” may be calculated 360 using “DH”, “V_{A}”, and “V_{R}”.

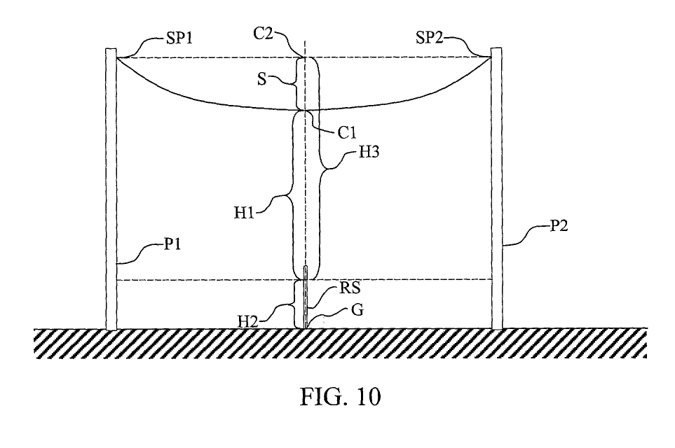

Continuing with the utility pole surveying example and referring to FIG. 10, the apparatus 100 may also be used to calculate the sag “S” of conductors hung between utility poles. To eliminate the need target the actual conductor, the user may place a reference stick “RS” directly under the lowest point of the conductor to use as a target object. Once the image and data are collected, the user simply identifies the ground reference point “G” at the base of the target, the point on the conductor substantially directly over the reference stick, and a point directly above that on an imaginary line drawn between the two utility poles from the conductor's point of attachment. The calculation of the distance between these points is then determined in the same manner previously described for substantially coplanar points.

A plurality of additional routines of the image processor calculate a number of geometric relationships between selected elements in an image. An exemplary routine calculates the diameter and circumference of substantially planar substantially cylindrical objects. This routine and device enables the user to determine the largest and smallest diameter along a substantially cylindrical object that actually tapers. Once the diameter is known, a myriad of other calculations may be performed including, for instance, a circumference calculation, a surface area calculation, and a volume calculation. In addition to cylindrical objects, an area and a perimeter of all planar geometric shapes may be easily calculated.

Referring to FIG. 6, the first step 410 in the pole diameter and circumference routine 400 is for the image processor 190 to retrieve an image and all associated data from the storage device database 110 for analysis. The second step 420 is to calculate the actual distance “DA” from the apparatus 100 to the pole attachment at reference point “A” and calculate the slope focal length to the attachment “f_{A}”. Once “DA” and “f_{A}” are known, the third step 430 calculates an image scale, which is a ratio of “DA” to “f_{A}”, at the reference point “A”. In the fourth step 440 the user selects a point at the right edge of the pole and a point at the left edge of the pole at the location that the pole diameter is desired. The image processor 190 automatically determines the distance in pixel units of measure between the selected points. The diameter of the pole at reference point “A” is then calculated 450 by multiplying the image scale at point “A” with the pixel separation distance. Lastly, once the diameter is known the circumference of the pole at point “A” is calculated 460 using principles of geometry. With the diameter known and the image processor's 190 ability to determine the distance between any two substantially coplanar points on the pole, a myriad of other calculations may be performed including, for instance, the surface area calculation and the volume calculation. Further, one with skill in the art can appreciate that in addition to cylindrical objects, the area and perimeter of all planar geometric shapes may be easily calculated by simply identifying the critical distances on the shape.

The image processor may also include a target object GPS coordinate routine 500. This routine utilizes the image capture device GPS coordinates in conjunction with the other database information to calculate the GPS coordinates of the target object 510. Using trigonometry, the routine computes the horizontal distance “DH” to the target object 520 using the distance measured “DM” from the range finding device 150 and the azimuth angle “βₛ” from the azimuth finding device 160. Next, the routine utilized the heading of the apparatus 100 in conjunction with the horizontal distance “DH” to compute the GPS coordinates of the target object 530. This aspect of the present invention is unique in that it enables the user to safely determine the geophysical location of target objects that may be inaccessible or expose a surveyor to undue risk of harm.

As represented in the various figures, the photogrammetric apparatus is not necessary shown to scale but is shown in one of many possible and equally desirable representative relative dimensional proportions, as will be apparent to those with skill in the art. For example, although the photogrammetric apparatus is shown to have a generally rectangular configuration, any of a wide variety of equally suitable 3-dimensional envelopes and profiles are available and would be compatible for purposes of and contemplated by the photogrammetric apparatus of the present invention.

Numerous alterations, modifications, and variations of the preferred embodiments, configurations, modifications, variations, and alternatives disclosed herein will be apparent to those skilled in the art and they are all contemplated to be within the spirit and scope of the instant invention. For example, although specific embodiments have been described in detail, those with skill in the art can understand that the preceding embodiments and variations can be further modified to incorporate various types of substitute and/or additional materials, component quantities, shapes, relative arrangement of elements, and dimensional and proportional configurations for compatibility with the wide variety of industrial, commercial, and professional services environments known to and available in the respective industries. Accordingly, even though only few variations of the present invention are described herein, it is to be understood that the practice of such additional modifications and variations and the equivalents thereof, are within the spirit and scope of the invention as defined in the following claims.

I claim:

1. A photogrammetric apparatus for capturing data on an object, comprising:
a storage device having a database;
an image capture device including an imager adapted to communicate to the database an image of the object;
bearing, range, and azimuth finding devices adapted to communicate to the database a heading, a real distance between an image plane of the imager and the object along an imager axis, and a zenith angle of a target point on the object;
an image processor adapted to measure at least one second distance between at least two of a plurality of substantially coplanar points on the object in a pixel unit of measure and at least one of real unit of measure;
wherein the image processor is further configured to be calibrated by receiving from the database and processing a calibration image having a plurality of target indicia that are a predetermined real distance apart;
wherein, to calibrate, the image processor measures in the pixel unit of measure a calibration distance between at least two of the plurality of target indicia in the calibration image and computes an average scale ratio of the predetermined real distance to the calibration distance to compute a calibrated focal length of the imager; and
whereby the image processor is thereby calibrated to compute the second distance in real units of measure.

2. The photogrammetric apparatus according to claim 1, further including an expandable external device port assembly in electronic communication with the storage device and image processor, the external device port assembly being configured for transmitting and receiving data.

3. The photogrammetric apparatus according to claim 1, further including a display device for viewing images from the database and at least one data input device in electronic communication with the image processor and database.

4. The photogrammetric apparatus according to claim 1, further including a global positioning system (GPS) adapted to communicate to the database a geophysical location of the apparatus.

5. The photogrammetric apparatus according to claim 4, wherein the image processor further computes a GPS coordinate set that corresponds to the geophysical location of the object using the processed image, the heading, the real distance, and the zenith angle stored in the database.

6. The photogrammetric apparatus according to claim 1, wherein the image processor further calculates:
1) the at least one second distance between a first and a second selected reference point by computing the sum of an “H1” distance between the first reference point from a horizontal line and an “H2” distance between the second reference point and the horizontal line;
2) a horizontal distance “DH” from the focal point “fₚ” to the object by multiplying the real distance “DM” with the sine of the zenith angle “βₛ”;
3) a first reference angle “Δβ_{A}” from the imager axis “IA” to a first reference point axis defined by a line from a focal point “fₚ” of the imager to the first reference point by computing the arc tangent of (a) a distance “P_{A}”, in the image plane and in the pixel unit of measure, between the imager axis and the first reference point axis, divided by (b) the calibrated to focal length “f”;
4) a second reference angle “ΔΔ_{R}” from the imager axis “IA” to a second reference point axis defined by a second line from the focal point of the imager to the second reference point by computing the arc tangent of (a) a distance “P_{R}”, in the image plane and in the pixel unit of measure, between the imager axis and the second reference point axis, divided by (b) the calibrated focal length “f”;
5) a first relative angle “V_{A}” from the first reference point axis to the horizontal line by computing the sum of (a) the difference between ninety degrees and the zenith angle “βₛ” and (b) the first reference angle “Δβ_{A}”;
6) a second relative angle “V_{R}” from the second reference point axis to the horizontal line by computing the negative of the sum of (a) the difference between ninety degrees and the zenith angle “βₛ” and (b) the second reference angle “Δβ_{R}”;
7) the “H1” distance by dividing the horizontal distance “DH” by the tangent of the first relative angle “V_{A}”; and
8) the “H2” distance by dividing the horizontal distance “DH” by the tangent of the second relative angle “V_{R}”.

7. The photogrammetric apparatus according to claim 1, wherein the object in the image is selected to be a utility conductor suspended from a first utility pole and a second utility pole,
wherein the image processor further calculates:
1) a first conductor reference point elevation above a ground reference point in the at least one real unit of measure at a first conductor reference point “C1” on the utility conductor by computing the sum of an “H1” distance between the conductor reference point from a horizontal line and an “H2” distance between the ground reference point and the horizontal line;
2) a connection line reference point elevation above a ground reference point in the at least one real unit of measure at a connection line reference point “C2” on a connection line from a first conductor suspension point “SP1” at the first utility pole “P1” to a second conductor suspension point “SP2” at the second utility pole “P2” directly above the first conductor reference point “C1” by computing the sum of an “H3” distance between the connection line reference point from a horizontal line and the “H2” distance between the ground reference point and the horizontal line;
3) a conductor sag distance “S” in the at least one real unit of measure by computing the difference between the connection line reference point elevation directly above the first conductor reference point and the first conductor reference point elevation at the first conductor reference point;
4) a horizontal distance “DH” from the focal point “fₚ” to the object by multiplying the real distance “DM” with the sine of the zenith angle “βₛ”;
5) a first reference angle “Δβ_{A1}” from the imager axis “IA” to a first conductor reference point axis defined by a line from a focal point “fₚ” of the imager to the first conductor reference point by computing the arc tangent of (a) a distance “P_{A1}”, in the image plane and in the pixel unit of measure, between the imager axis and the first conductor reference point axis, divided by (b) the calibrated focal length “f”;
6) a second reference angle “Δβ_{R}” from the imager axis “IA” to a ground reference point axis defined by a second line from the focal point “fₚ” of the imager to the ground reference point by computing the arc tangent of (a) a distance “P_{R}”, in the image plane and in the pixel unit of measure, between the imager axis and the ground reference point axis, divided by (b) the calibrated focal length “f”;
7) a third reference angle “Δβ_{A2}” from the imager axis “IA” to a connection line reference point axis defined by a line from a focal point “fₚ” of the imager to the connection line reference point by computing the arc tangent of (a) a distance “P_{A2}”, in the image plane and in the pixel unit of measure, between the imager axis and the connection line reference point axis, divided by (b) the calibrated focal length “f”;
8) a first relative angle “V_{A1}” from the conductor reference point axis to the horizontal line by computing the sum of (a) the difference between ninety degrees and the zenith angle “βₛ” and (b) the first reference angle “Δβ_{A1}”;
9) a second relative angle “V_{R}” from the ground reference point axis to the horizontal line by computing the negative of the sum of (a) the difference between ninety degrees and the zenith angle “βₛ” and (b) the second reference angle “Δβ_{R}”;
10) a third relative angle “V_{A2}” from the connection line reference point axis to the horizontal line by computing the sum of (a) the difference between ninety degrees and the zenith angle “βₛ” and (b) the first reference angle “Δβ_{A2}”;
10) the “H1” distance by dividing the horizontal distance “DH” by the tangent of the first relative angle “V_{A1}”;
11) the “H2” distance by dividing the horizontal distance “DH” by the tangent of the second relative angle “V_{R}”; and
12) the “H3” distance by dividing the horizontal distance “DH” by the tangent of the third relative angle “V_{A2}”.

8. The photogrammetric apparatus according to claim 1, wherein the image processor further calculates a plurality of geometric relationships between the at least two substantially coplanar points on the object using the at least one second distance and a plurality of additional second distances measured between respective additional coplanar points of the plurality of substantially coplanar points on the object.

9. The photogrammetric apparatus according to claim 8, wherein the object in the image is selected to be a substantially cylindrical object,
wherein the image processor further calculates:
1) a diameter in the at least one real unit of measure of the substantially cylindrical object at a reference point “A” that is not on the image axis by multiplying (a) an image scale proximate to the reference point by (b) the at least one second distance in the pixel unit of measure, which is selected to be between one edge of the cylindrical object and an opposite edge;
2) a reference angle “Δβ_{A}” from the imager axis “IA” to a reference point axis defined by a line from a focal point of the imager to the reference point by computing the arc tangent of (a) a distance “P_{A}”, in the image plane and in the pixel unit of measure, between the imager axis and the reference point axis, divided by (b) the calibrated focal length “f”;
3) a relative angle “V_{A}” from the reference point axis to the horizontal line by computing the sum of (a) the difference between ninety degrees and the zenith angle “βₛ” and (b) the reference angle “Δβ_{A}”;
4) the image scale at the reference point “A” by computing the division of (a) a slope distance “DA” to the reference point, which is computed by division of (i) the horizontal distance to the object “DH” by (ii) the cosine of the relative angle “V_{A}”, by (b) a slope focal length “f_{A}” to the reference point, which is computed by division of (i) the calibrated focal length by (ii) the cosine of the reference angle “Δβ_{A}”.

10. A photogrammetric apparatus for capturing data on an object, comprising:
a storage device having a database;
an image capture device including an imager adapted to communicate to the database an image of the object;
bearing, range, azimuth, and global positioning system coordinate finding devices adapted to communicate to the database a heading, a real distance between an image plane of the imager and the object along an imager axis, and a zenith angle of a target point on the object;
an image processor adapted to measure at least one second distance between at least two of a plurality of substantially coplanar points on the object in a pixel unit of measure and at least one of real unit of measure;
wherein the image processor is further configured to be calibrated by receiving from the database and processing a calibration image having a plurality of target indicia that are a predetermined real distance apart;
wherein, to calibrate, the image processor measures in the pixel unit of measure a calibration distance between at least two of the plurality of target indicia in the calibration image and computes an average scale ratio of the predetermined real distance to the calibration distance to compute a calibrated focal length of the imager; and
whereby the image processor is thereby calibrated to compute the second distance in real units of measure.

11. The photogrammetric apparatus according to claim 10, wherein the image processor further computes a GPS coordinate set that corresponds to the geophysical location of the object using the image, the heading, the real distance, and the zenith angle stored in the database.

12. The photogrammetric apparatus according to claim 10, wherein the image processor further calculates:
1) the at least one second distance between a first and a second selected reference point by computing the sum of an “H1” distance between the first reference point from a horizontal line and an “H2” distance between the second reference point and the horizontal line;
2) a horizontal distance “DH” from the focal point “fₚ” to the object by multiplying the real distance “DM” with the sine of the zenith angle “βₛ”;
3) a first reference angle “Δβ_{A}” from the imager axis “IA” to a first reference point axis defined by a line from a focal point of the imager to the first reference point by computing the arc tangent of (a) a distance “P_{A}”, in the image plane and in the pixel unit of measure, between the imager axis and the first reference point axis, divided by (b) the calibrated focal length “f”;
4) a second reference angle “Δβ_{R}” from the imager axis “IA” to a second reference point axis defined by a second line from the focal point of the imager to the second reference point by computing the arc tangent of (a) a distance “P_{R}”, in the image plane and in the pixel unit of measure, between the imager axis and the second reference point axis, divided by (b) the calibrated focal length “f”;
5) a first relative angle “V_{A}” from the first reference point axis to the horizontal line by computing the sum of (a) the difference between ninety degrees and the zenith angle “βₛ” and (b) the first reference angle “Δβ_{A}”;
6) a second relative angle “V_{R}” from the second reference point axis to the horizontal line by computing the negative of the sum of (a) the difference between ninety degrees and the zenith angle “βₛ” and (b) the second reference angle “Δβ_{R}”;
7) the “H1” distance by dividing the horizontal distance “DH” by the tangent of the first relative angle “V_{A}”; and
8) the “H2” distance by dividing the horizontal distance “DH” by the tangent of the second relative angle “V_{R}”.

13. The photogrammetric apparatus according to claim 10, wherein the object in the image is selected to be a utility conductor suspended from a first utility pole and a second utility pole,
wherein the image processor further calculates:
1) a first conductor reference point elevation above a ground reference point in the at least one real unit of measure at a first conductor reference point “C1” on the utility conductor 1, by computing the sum of an “H1” distance between the conductor reference point from a horizontal line and an “H2” distance between the ground reference point and the horizontal line;
2) a connection line reference point elevation above a ground reference point in the at least one real unit of measure at a connection line reference point “C2” on a connection line from a first conductor suspension point “SP1” at the first utility pole “P1” to a second conductor suspension point “SP2” at the second utility pole “P2” directly above the first conductor reference point “C1” by computing the sum of an “H3” distance between the connection line reference point from a horizontal line and the “H2” distance between the ground reference point and the horizontal line;
3) a conductor sag distance “S” in the at least one real unit of measure by computing the difference between the connection line reference point elevation directly above the first conductor reference point and the first conductor reference point elevation at the first conductor reference point;
4) a horizontal distance “DH” from the focal point “fₚ” to the object by multiplying the real distance “DM” with the sine of the zenith angle “βₛ”;
5) a first reference angle “Δβ_{A1}” from the imager axis “IA” to a first conductor reference point axis defined by a line from a focal point “fₚ” of the imager to the first conductor reference point by computing the arc tangent of (a) a distance “P_{A1}”, in the image plane and in the pixel unit of measure, between the imager axis and the first conductor reference point axis, divided by (b) the calibrated local length “f”;
6) a second reference angle “ΔP_{R}” from the imager axis “IA” to a ground reference is point axis defined by a second line from the focal point “fₚ” of the imager to the ground reference point by computing the arc tangent of (a) a distance “P_{R}”, in the image plane and in the pixel unit of measure, between the imager axis and the ground reference point axis, divided by (b) the calibrated focal length “f”;
7) a third reference angle “≢β_{A2}” from the imager axis “IA” to a connection line reference point axis defined by a line from a focal point “fₚ” of the imager to the connection line reference point by computing the arc tangent of (a) a distance “P_{A2}”, in the image plane and in the pixel unit of measure, between the imager axis and the connection line reference point axis, divided by (b) the calibrated focal length “f”;
8) a first relative angle “V_{A1}” from the conductor reference point axis to the horizontal line by computing the sum of (a) the difference between ninety degrees and the zenith angle “βₛ” and (b) the first reference angle “Δβ_{R}”;
9) a second relative angle “V_{R}” from the ground reference point axis to the horizontal line by computing the negative of the sum of (a) the difference between ninety degrees and the zenith angle “βₛ” and (b) the second reference angle “Δβ_{R}”;
10) a third relative angle “V_{A2}” from the connection line reference point axis to the horizontal line by computing the sum of (a) the difference between ninety degrees and the zenith angle “βₛ” and (b) the first reference angle “Δβ_{A2}”;
10) the “H1” distance by dividing the horizontal distance “DH” by the tangent of the first relative angle “V_{A1}”;
11) the “H2” distance by dividing the horizontal distance “DH” by the tangent of the second relative angle “V_{R}”; and
12) the “H3” distance by dividing the horizontal distance “DH” by the tangent of the third relative angle “V_{A2}”.

14. The photogrammetric apparatus according to claim 10, wherein the image processor further calculates a plurality of geometric relationships between the at least two substantially coplanar points on the object using the at least one second distance and a plurality of additional second distances measured between respective additional coplanar points of the plurality of substantially coplanar points on the object.

15. The photogrammetric apparatus according to claim 14, wherein the object in the image is selected to be a substantially cylindrical object,
wherein the image processor further calculates:
1) a diameter in the at least one real unit of measure of the substantially cylindrical object at a reference point “A” that is not on the image axis by multiplying (a) an image scale proximate to the reference point by (b) the at least one second distance in the pixel unit of measure, which is selected to be between one edge of the cylindrical object and an opposite edge;
2) a reference angle “Δβ_{A}” from the imager axis “IA” to a reference point axis defined by a line from a focal point of the imager to the reference point by computing the arc tangent of (a) a distance “P_{A}”, in the image plane and in the pixel unit of measure, between the imager axis and the reference point axis, divided by (b) the calibrated focal length “f”;
3) a relative angle “V_{A}” from the reference point axis to the horizontal line by computing the sum of (a) the difference between ninety degrees and the zenith angle “βₛ” and (b) the reference angle “Δβ_{A}”;
4) the image scale at the reference point “A” by computing the division of (a) a slope distance “DA” to the reference point, which is computed by division of (i) the horizontal distance to the object “DH” by (ii) the cosine of the relative angle “V_{A}”, by (b) a slope focal length “f_{A}” to the reference point, which is computed by division of (i) the calibrated focal length by (ii) the cosine of the reference angle “Δβ_{A}”.

16. A photogrammetric apparatus for capturing data on an object, comprising:
a storage device having a database;
an image capture device including an imager adapted to communicate to the database an image of the object;
bearing, range, and azimuth finding devices adapted to communicate to the database a heading, a real distance between an image plane of the imager and the object along an imager axis, and a zenith angle of a target point on the object;
a plurality of input and output devices in electronic communication with the database and the image processor, the plurality of devices including a display, a keyboard, and a plurality of pointing devices for identifying points on the display.
an image processor adapted to measure at least one second distance between at least two of a plurality of substantially coplanar points on the object in a pixel unit of measure and at least one of real unit of measure;
wherein the image processor is further configured to be calibrated by receiving from the database and processing a calibration image having a plurality of target indicia that are a predetermined real distance apart;
wherein, to calibrate, the image processor measures in the pixel unit of measure a calibration distance between at least two of the plurality of target indicia in the calibration image and computes an average scale ratio of the predetermined real distance to the calibration distance to compute a calibrated focal length of the imager; and
whereby the image processor is thereby calibrated to compute the second distance in real units of measure.

17. The photogrammetric apparatus according to claim 16, wherein the image processor further computes a GPS coordinate set that corresponds to the geophysical location of the object using the image, the heading, the real distance, and the zenith angle stored in the database.

18. The photogrammetric apparatus according to claim 16, wherein the image processor further calculates:
1) the at least one second distance between a first and a second selected reference point by computing the sum of an “H1” distance between the first reference point from a horizontal line and an “H2” distance between the second reference point and the horizontal line;
2) a horizontal distance “DH” from the focal point “fₚ” to the object by multiplying the real distance “DM” with the sine of the zenith angle “βₛ”;
3) a first reference angle “Δβ_{A}” from the imager axis “IA” to a first reference point axis defined by a line from a focal point of the imager to the first reference point by computing the arc tangent of (a) a distance “P_{A}”, in the image plane and in the pixel unit of measure, between the imager axis and the first reference point axis, divided by (b) the calibrated focal length “f”;
4) a second reference angle “Δβ_{R}” from the imager axis “IA” to a second reference point axis defined by a second line from the focal point of the imager to the second reference point by computing the arc tangent of (a) a distance “P_{R}”, in the image plane and in the pixel unit of measure, between the imager axis and the second reference point axis, divided by (b) the calibrated focal length “f”;
5) a first relative angle “V_{A}” from the first reference point axis to the horizontal line by computing the sum of (a) the difference between ninety degrees and the zenith angle “βₛ” and (b) the first reference angle “Δβ_{A}”;
6) a second relative angle “V_{R}” from the second reference point axis to the horizontal line by computing the negative of the sum of (a) the difference between ninety degrees and the zenith angle “βₛ” and (b) the second reference angle “Δβ_{R}”;
7) the “H1” distance by dividing the horizontal distance “DH” by the tangent of the first relative angle “V_{A}”; and
8) the “H2” distance by dividing the horizontal distance “DH” by the tangent of the second relative angle “V_{R}”.

19. The photogrammetric apparatus according to claim 16, wherein the object in the image is selected to be a utility conductor suspended from a first utility pole and a second utility pole,
wherein the image processor further calculates:
1) a first conductor reference point elevation above a ground reference point in the at least one real unit of measure at a first conductor reference point “C1” on the utility conductor by computing the sum of an “H1” distance between the conductor reference point from a horizontal line and an “H2” distance between the ground reference point and the horizontal line;
2) a connection line reference point elevation above a ground reference point in the at least one real unit of measure at a connection line reference point “C2” on a connection line from a first conductor suspension point “SP1” at the first utility pole “P1” to a second conductor suspension point “SP2” at the second utility pole “P2” directly above the first conductor reference point “C1” by computing the sum of an “H3” distance between the connection line reference point from a horizontal line and the “H2” distance between the ground reference point and the horizontal line;
3) a conductor sag distance “S” in the at least one real unit of measure by computing the difference between the connection line reference point elevation directly above the first conductor reference point and the first conductor reference point elevation at the first conductor reference point;
4) a horizontal distance “DH” from the focal point “fₚ” to the object by multiplying the real distance “DM” with the sine of the zenith angle “βₛ”;
5) a first reference angle “Δβ_{A1}” from the imager axis “IA” to a first conductor reference point axis defined by a line from a focal point “fₚ” of the imager to the first conductor reference point by computing the arc tangent of (a) a distance “P_{A1}”, in the image plane and in the pixel unit of measure, between the imager axis and the first conductor reference point axis, divided by (b) the calibrated focal length “f”;
6) a second reference angle “Δβ_{R}” from the imager axis “IA” to a ground reference point axis defined by a second line from the focal point “fₚ” of the imager to the ground reference point by computing the arc tangent of (a) a distance “P_{R}”, in the image plane and in the pixel unit of measure, between the imager axis and the ground reference point axis, divided by (b) the calibrated focal length “f”;
7) a third reference angle “Δβ_{A2}” from the imager axis “IA” to a connection line reference point axis defined by a line from a focal point “fₚ” of the imager to the connection line reference point by computing the arc tangent of (a) a distance “P_{A2}”, in the image plane and in the pixel unit of measure, between the imager axis and the connection line reference point axis, divided by (b) the calibrated focal length “f”;
8) a first relative angle “V_{A1}” from the conductor reference point axis to the horizontal line by computing the sum of (a) the difference between ninety degrees and the zenith angle “βₛ” and (b) the first reference angle “Δβ_{A1}”;
9) a second relative angle “V_{R}” from the ground reference point axis to the horizontal line by computing the negative of the sum of (a) the difference between ninety degrees and the zenith angle “βₛ” and (b) the second reference angle “Δβ_{R}”;
10) a third relative angle “V_{A2}” from the connection line reference point axis to the horizontal line by computing the sum of (a) the difference between ninety degrees and the zenith angle “βₛ” and (b) the first reference angle “Δβ_{A2}”;
10) the “H1” distance by dividing the horizontal distance “DH” by the tangent of the first relative angle “V_{A1}”;
11) the “H2” distance by dividing the horizontal distance “DH” by the tangent of the second relative angle “V_{R}”; and
12) the “H3” distance by dividing the horizontal distance “DH” by the tangent of the third relative angle “V_{A2}”.

20. The photogrammetric apparatus according to claim 16, wherein the image processor further calculates a plurality of geometric relationships between the at least two substantially coplanar points on the object using the at least one second distance and a plurality of additional second distances measured between respective additional coplanar points of the plurality of substantially coplanar points on the object.

21. The photogrammetric apparatus according to claim 20, wherein the object in the image is selected to be a substantially cylindrical object,
wherein the image processor further calculates:
1) a diameter in the, at least one real unit of measure of the substantially cylindrical object at a reference point “A” that is not on the image axis by multiplying (a) an image scale proximate to the reference point by (b) the at least one second distance in the pixel unit of measure, which is selected to be between one edge of the cylindrical object and an opposite edge;
2) a reference angle “Δβ_{A}” from the imager axis “IA” to a reference point axis defined by a line from a focal point of the imager to the reference point by computing the arc tangent of (a) a distance “P_{A}”, in the image plane and in the pixel unit of measure, between the imager axis and the reference point axis, divided by (b) the calibrated focal length “f”;
3) a relative angle “V_{A}” from the reference point axis to the horizontal line by computing the sum of (a) the difference between ninety degrees and the zenith angle “βₛ” and (b) the reference angle “Δβ_{A}”;
4) the image scale at the reference point “A” by computing the division of (a) a slope distance “DA” to the reference point, which is computed by division of (i) the horizontal distance to the object “DH” by (ii) the cosine of the relative angle “V_{A}”, by (b) a slope focal length “f_{A}” to the reference point, which is computed by division of (i) the calibrated focal length by (ii) the cosine of the reference angle “Δβ_{A}”.

22. A photogrammetric apparatus for capturing data on an object, comprising:
a storage device having a database;
an image capture device including an imager adapted to communicate to the database an image of the object;
bearing, range, azimuth, and global positioning system coordinate finding devices adapted to communicate to the database a heading, a real distance between an image plane of the imager and the object along an imager axis, and a zenith angle of a target point on the object;
a plurality of input and output devices in electronic communication with the database and the image processor, the plurality of devices including a display, a keyboard, and a plurality of pointing devices for identifying points on the display.
an expandable external device port assembly in electronic communication with the storage device and image processor, the external device port assembly being configured for transmitting and receiving data therewith;
an image processor adapted to measure at least one second distance between at least two of a plurality of substantially coplanar points on the object in a pixel unit of measure and at least one of real unit of measure;
wherein the image processor is further configured to be calibrated by receiving from the database and processing a calibration image having a plurality of target indicia that are a predetermined real distance apart;
wherein, to calibrate, the image processor measures in the pixel unit of measure a calibration distance between at least two of the plurality of target indicia in the calibration image and computes an average scale ratio of the predetermined real distance to the calibration distance to compute a calibrated focal length of the imager;
wherein the image processor is thereby calibrated to compute the second distance in real units of measure;
wherein the image processor computes a GPS coordinate set that corresponds to the geophysical location of the object using the image, the heading, the real distance, and the zenith angle stored in the database;
wherein the image processor further calculates:
1) the at least one second distance between a first and a second selected reference point by computing the sum of an “H1” distance between the first reference point from a horizontal line and an “H2” distance between the second reference point and the horizontal line;
2) a horizontal distance “DH” from the focal point “fₚ” to the object by multiplying the real distance “DM” with the sine of the zenith angle “βₛ”;
3) a first reference angle “Δβ_{A}” from the imager axis “IA” to a first reference point axis defined by a line from a focal point of the imager to the first reference point by computing the arc tangent of (a) a distance “P_{A}”, in the image plane and in the pixel unit of measure, between the imager axis and the first reference point axis, divided by (b) the calibrated focal length “f”;
4) a second reference angle “Δβ_{R}” from the imager axis “IA” to a second reference point axis defined by a second line from the focal point of the imager to the second reference point by computing the arc tangent of (a) a distance “P_{R}”, in the image plane and in the pixel unit of measure, between the imager axis and the second reference point axis, divided by (b) the calibrated focal length “f”;
5) a first relative angle “V_{A}” from the first reference point axis to the horizontal line by computing the sum of (a) the difference between ninety degrees and the zenith angle “βₛ” and (b) the first reference angle “Δβ_{A}”;
6) a second relative angle “V_{R}” from the second reference point axis to the horizontal line by computing the negative of the sum of (a) the difference between ninety degrees and the zenith angle “βₛ” and (b) the second reference angle “Δβ_{R}”;
7) the “H1” distance by dividing the horizontal distance “DH” by the tangent of the first relative angle “V_{A}”; and
8) the “H2” distance by dividing the horizontal distance “DH” by the tangent of the second relative angle “V_{R}”;
wherein the image processor further calculates a plurality of geometric relationships between the at least two substantially coplanar points on the object using the at least one second distance and a plurality of additional second distances measured between respective additional coplanar points of the plurality of substantially coplanar points on the object.

23. The photogrammetric apparatus according to claim 22, wherein the object in the image is selected to be a substantially cylindrical object, and wherein the image processor further calculates:
1) a diameter in the at least one real unit of measure of the substantially cylindrical object at a reference point “A” that is not on the image axis by multiplying (a) an image scale proximate to the reference point by (b) the at least one second distance in the pixel unit of measure, which is selected to be between one edge of the cylindrical object and an opposite edge;
2) a reference angle “Δβ_{A}” from the imager axis “IA” to a reference point axis defined by a line from a focal point of the imager to the reference point by computing the arc tangent of (a) a distance “P_{A}”, in the image plane and in the pixel unit of measure, between the imager axis and the reference point axis, divided by (b) the calibrated focal length “f”;
3) a relative angle “V_{A}” from the reference point axis to the horizontal line by computing the sum of (a) the difference between ninety degrees and the zenith angle “βₛ” and (b) the reference angle “Δβ_{A}”;
4) the image scale at the reference point “A” by computing the division of (a) a slope distance “DA” to the reference point, which is computed by division of (i) the horizontal distance to the object “DH” by (ii) the cosine of the relative angle “V_{A}”, by (b) a slope focal length “f_{A}” to the reference point, which is computed by division of (i) the calibrated focal length by (ii) the cosine of the reference angle “Δβ_{A}”.
